(19) United States
(12) Patent Application Publication
(10) Pub. No.: US 2002/0008679 A1
(43) Pub. Date: Jan. 24, 2002

(54) Sub-field white balance electronically controlled for plasma display panel device

(76) Inventor: James C. Rutherford, Fort Wayne, IN (US)

Correspondence Address: George Pappas, PAPPAS LAW OFFICE, 919 S. Harrison Street, Suite 300, Fort Wayne, IN, 46802, US

(21) Appl. No.: 09/908,097

(22) Filed: Jul. 18, 2001

Related U.S. Application Data
(60) Provisional application No. 60/219,706, filed on Jul. 19, 2000.

(51) Int. Cl. G09G 3/28

(52) U.S. Cl. 345/60; 345/63

(57) ABSTRACT

Method for controlling a white balance in a plasma display panel device, is disclosed, in which the sub-field sustain pulses for R (Red), G (Green), and B (Blue) cells are reduced by a different amount from one another. This enables white balance adjustment between the R, G, B cells having equally designed pitch, but with differences of luminance.

Applicant hereby claims priority of Provisional U.S. Application No. 60/219,706 filed Jul. 19, 2000.

### FIELD OF THE INVENTION

The present invention relates to a plasma display panel (PDP) device, and more particularly, to a method for controlling a white balance in a plasma display panel device, in which the R (Red) cell, G (Green) cell, and a B (Blue) cell sustain pulses are reduced by a different amount from one another in each sub-field. This enables the controlling of white balance for R, G, B cells having equally designed pitch, but with differences of luminance.

### DISCUSSION OF THE RELATED ART

The PDP is a flat display device of a self-luminous type, having a pair of substrates as a support. Since a PDP capable of color display was put to practical use, the PDP has wider applications, for example, as a display of television pictures or a monitor of a computer. The PDP is now attracting attention also as a large, flat display device for high-definition TV.

In the PDP of FIG. 1 using a matrix display system, a memory effect is employed for sustaining a light-emitting state of cells, which are display elements. The AC-driven PDP of FIG. 2 is so constructed to structurally have a memory function by means of a dielectric layer covering electrodes “17”. For displaying an image by the AC-driven PDP, sequential addressing is carried out line by line to select and charge only cells which are to emit light, and then a sustain voltage of alternating polarity for sustaining a light-emitting state, i.e., for sustaining repeated light-emission discharges for display, is applied to all cells being sustained simultaneously. The sustain voltage is a predetermined voltage which is lower than a firing voltage, i.e., a discharge start voltage. In a cell having wall charge, the wall charge is superposed on the sustain voltage to form an effective voltage which is actually applied to the cell. When the effective voltage exceeds the firing voltage, an electric discharge takes place and the cell emits light. If the sustain voltage is repeatedly applied at a short cycle, apparently continuous light emission can be obtained. Luminance of display depends on “integrated luminescence intensity” which is the total amount of light emitted during a sustain period for sustaining the light-emission discharges. Usually, the frequency of a sustain voltage pulse which determines a discharge cycle is constant. Therefore the length of the sustain period, i.e., the number of discharges, is dependent on an intended luminance.

As color display devices, AC-driven PDPs of a surface discharge type have become commercial. The surface discharge type is a system FIG. 2, wherein pairs of main electrodes, i.e., pairs of first “X” and second “Y”, electrodes which alternately become positive or negative for sustaining the light-emission discharges, are arranged in parallel on one of a pair of substrates. Since the main electrodes extend in the same direction, third electrodes intersecting the main electrodes need to be provided for selecting individual cells. The third electrodes “A” are disposed on the other substrate in an opposing relation to the main electrodes with a discharge gas space there between in order to reduce electrostatic capacity of the cells. An electric discharge is generated for addressing across one of the main electrodes and the third electrode. In such PDPs having a three-electrode structure, fluorescent layers for color display can be provided on the on the other substrate opposite to the substrate on which the main electrodes are placed, in order to reduce deterioration of the fluorescent layers by ion impact at electric discharges and to increase the life of the devices.

The sub-field method for displaying a motion picture or a still picture on the aforementioned plasma display panel will be explained.

The sub-field system has an X number of sub-fields in a frame, with each of the subfields corresponded to one of luminance's having relative ratios for implementing gray levels, thereby a picture corresponding to a number of gradation can be displayed by combining or accumulating a certain number of the sub-fields.

In the gray scale implementation with the aforementioned sub-field system, luminances of the R, G, B cells by the gradation data (digital video data) provided to the R, G, B cells are dependent on numbers of the first and second sustain pulses provided to the plurality of sub-fields, and a combination of the luminance of the R, G, B cells forms a color of a pixel. In other words, combinations of red, blue, green visible lights emitted at proper luminance from the R, G, B cells in the pixel depending on the digital R, G, B video data (each has a number of bits identical to a number of sub-fields) provided to address electrode lines for the three R, G, B cells for one frame duration implements various colors of the pixel. If the R, G, B cells in the pixel are provided with the same gradation data, white color (achromatic color) is displayed theoretically, and if provided with gradation data different from one another, various colors can be displayed according to ratios of the luminance of the R, G, B cells.

However, because luminous efficiencies of the R, G, B fluorescent materials coated on the R, G, B cells respectively on the plasma display panel are, as known, in general in the order of G fluorescent material>R fluorescent material>B fluorescent material, if discharge space sizes of the R, G, B cells and numbers of the sustain pulses corresponding to the gradation data of the R, G, B cells are the same as the known art, there has been problems that an imbalance in the white balance is occurred such that a greenish white is displayed in an implementation of a white color on a pixel and exact implementations of other colors are not possible because the luminance of the R, G, B cells according to the provided same gradation data are in the order of G cell>R cell>B cell.

To reduce the effect of above problem caused by improper white balance one method is directed for controlling white balance in a plasma display panel device which adds to each frame a different number of Red, Green, Blue sustain pulses. This is an imperfect method to achieve white balance because of all the different variations that must be compensated for. Also, three additional sub-fields are needed to implement this method. This could be a major problem for higher resolution displays that would have more rows to be addressed.

Asymmetric cell design is another approach to achieve white balance. By being able to control white balance electronically, the gain of individual color signals can be adjusted for a television use. Therefore, asymmetric cell design is not required to produce a white balance. Keeping cell design symmetric avoids the problem of different discharge voltage for each color cell of the asymmetric design. This will be critical especially in addressing because the address driver ICs should control discharges in color channels with different widths. Different addressing characteristics for each discharge cell may decrease the address margin, and eventually results in unstable panel operation.

### SUMMARY OF THE INVENTION

Accordingly, the present invention is directed to a method for electronically controlling a white balance in a plasma display panel device that substantially obviates one or more of the problems due to limitations and disadvantages of the related art.

Additional features and advantages of the invention will be set forth in the description, which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the method for controlling a white balance in a plasma display panel device includes the steps of (1) displaying one sub-field of picture in each drive block connected to the screen of the plasma display device; (2) subtract or add sustain pulses in each drive block, the number of sustain pulses is based on how many cells are on in the drive block; (3) nearing the end for the sustain pulses for a sub-field, in a drive block, an erasure of green cells only is performed; (4) sustain pulses are continued in the drive block so that on red and blue cells continue to emit light, (5) erasure is now performed in the drive block on red cells only; (6) sustain pulses are continued in the drive block which results in only on blue cells emitting light; (7) erasure of on blue cells is performed in preparation for next sub-field. The order of color erasure in steps 3 through 7 may be in any order or combination of colors.

The number of sustain pulses after a color erasure may be varied to appropriate ratios according to luminance or contrast of the screen for keeping the white balance stable regardless of variation of the luminance or contrast of the screen.

In one form thereof the present invention is directed to a method of driving a plasma display panel having a plurality of independently driven display drive blocks of green, red and blue cells and wherein each image is displayed on the panel by addressing on desired green, red and blue cells in each drive block and sustaining the on cells with a desired number of sustain pulses. The method includes the step of adjusting the number of sustain pulses of one of the green, red or blue cells of each drive block, whereby white balance is obtained on the display panel.

Preferably, prior to the step of adjusting, the number of on green, red and blue cells of each display drive block is determined and the adjustment for each drive block is established by the number of on green, red and blue cells in the drive block. Further, during the step of adjusting, the number of sustain pulses of the green cells is decreased and, also, the number of sustain pulses of the red cells is decreased.

### BRIEF DESCRIPTION OF THE DRAWINGS

The above mentioned and other features and objects of this invention and the manner of obtaining them will become more apparent and the invention itself will be better understood by reference to the following description of embodiments of the invention taken in conjunction with the accompanying drawings wherein:

FIG. 1 is a prior art diagram illustrating the structure of a plasma display; FIG. 2 is a prior art perspective view illustrating the inner construction of a PDP;

FIG. 3 is a diagram illustrating the structure of a plasma display in accordance with the present invention;

FIG. 4 is a table of a 1080 row plasma display panel that has five drive blocks and twelve subfields in accordance with the present invention;

FIG. 5 illustrates a flow chart showing the steps of a method for controlling a white balance in a plasma display panel device on a subfield bases in accordance with a preferred embodiment of the present invention;

FIG. 6 shows waveforms illustrating an example of color erasure in accordance with the present invention.

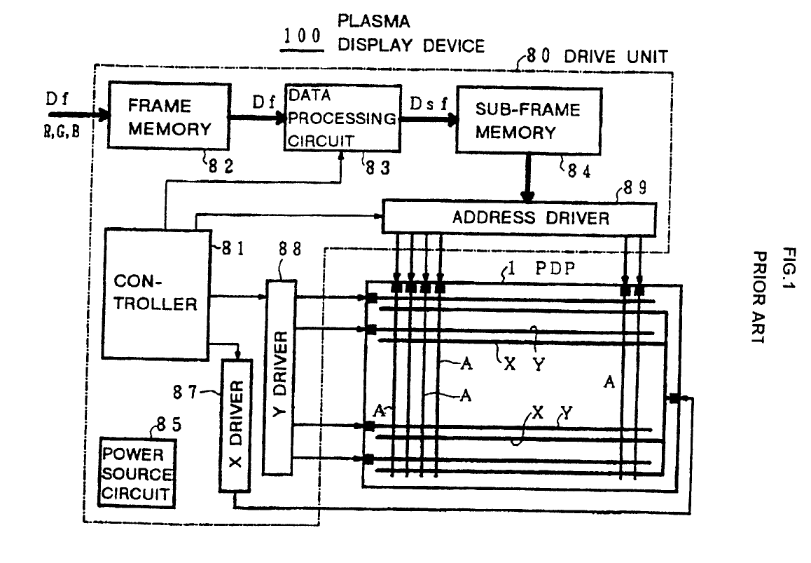

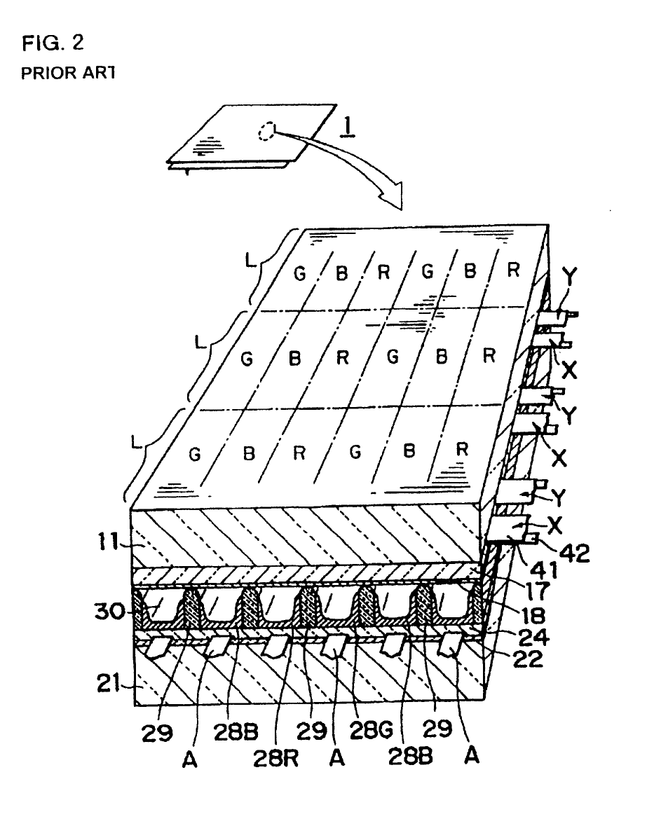

Corresponding reference characters indicate corresponding parts throughout the several views of the drawings.

The exemplifications set out herein illustrate preferred embodiments of the invention in one form thereof and such exemplifications are not to be construed as limiting the scope of the disclosure or the scope of the invention in any manner.

### DESCRIPTION OF THE PREFERRED EMBODIMENTS

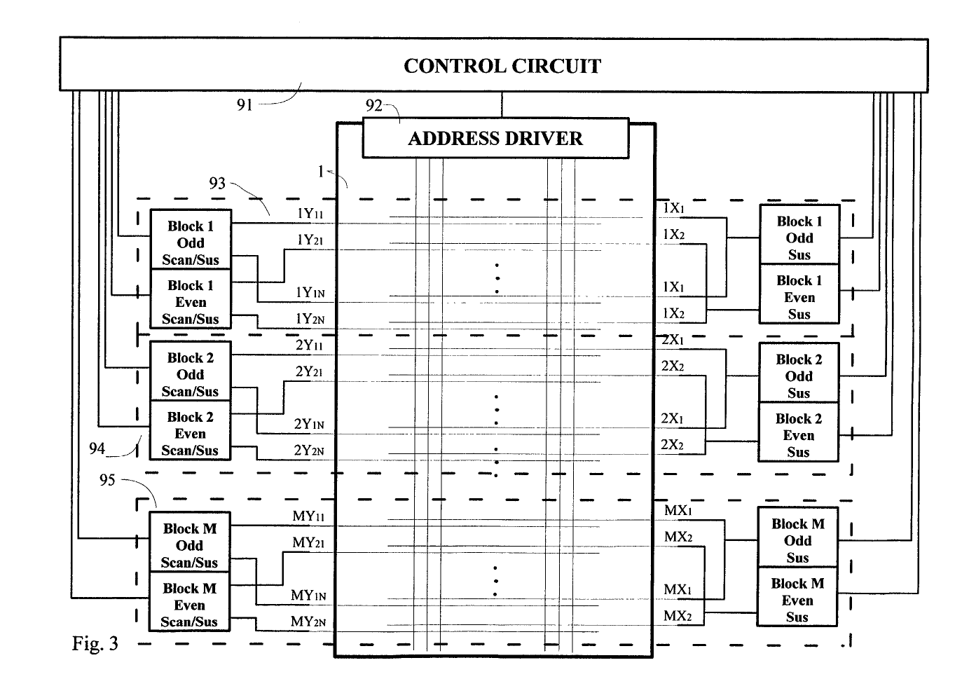

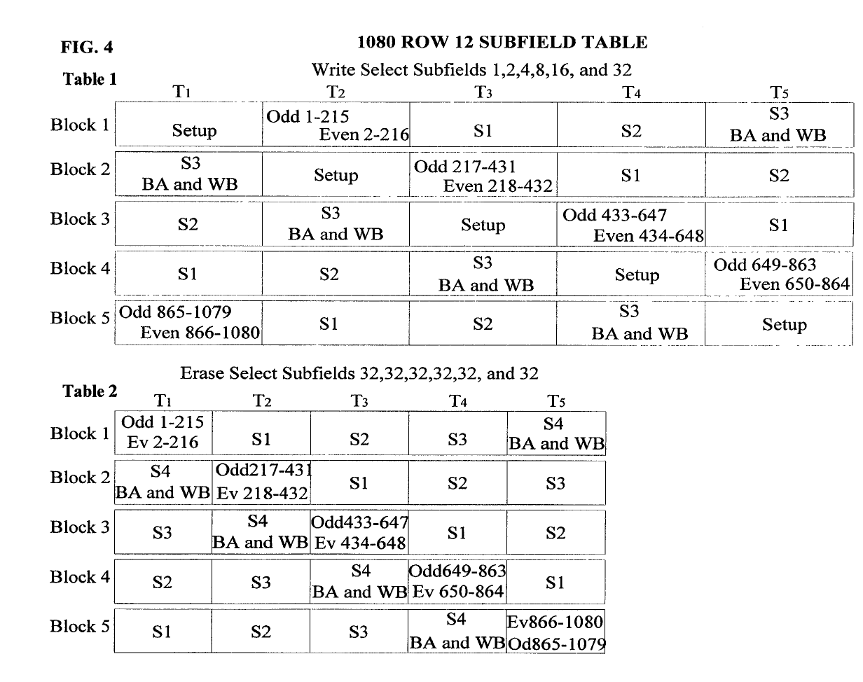

The new drive method ADT, will be used for the setup, addressing and sustaining functions for the plasma display panel device. In this drive scheme the PDP is divided into blocks, illustrated in FIG. 3, which have independent controlled drive electronics “93˜95”. As illustrated in Table 1 of FIG. 4, this makes possible at time T₁ of Block 1 to be doing a setup function, Block 5 to be doing an addressing function while Blocks 3 and 4 may have sustain pulses producing light output in the plasma display panel device. Block 2 at time T₁ has a continuation of the sustain pulses producing light output, plus brightness adjustment needed to correct for changes in cell loading and white balance adjustment.

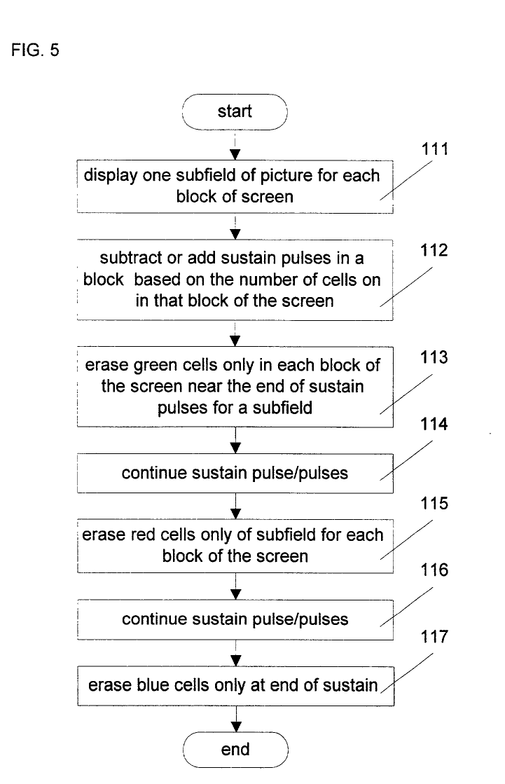

FIG. 5 illustrates a flow chart showing the steps of a method for controlling a white balance in a plasma display panel device in accordance with a preferred embodiment of the present invention.

The method for controlling a white balance in the aforementioned plasma display panel device in accordance with a preferred embodiment of the present invention will be explained.

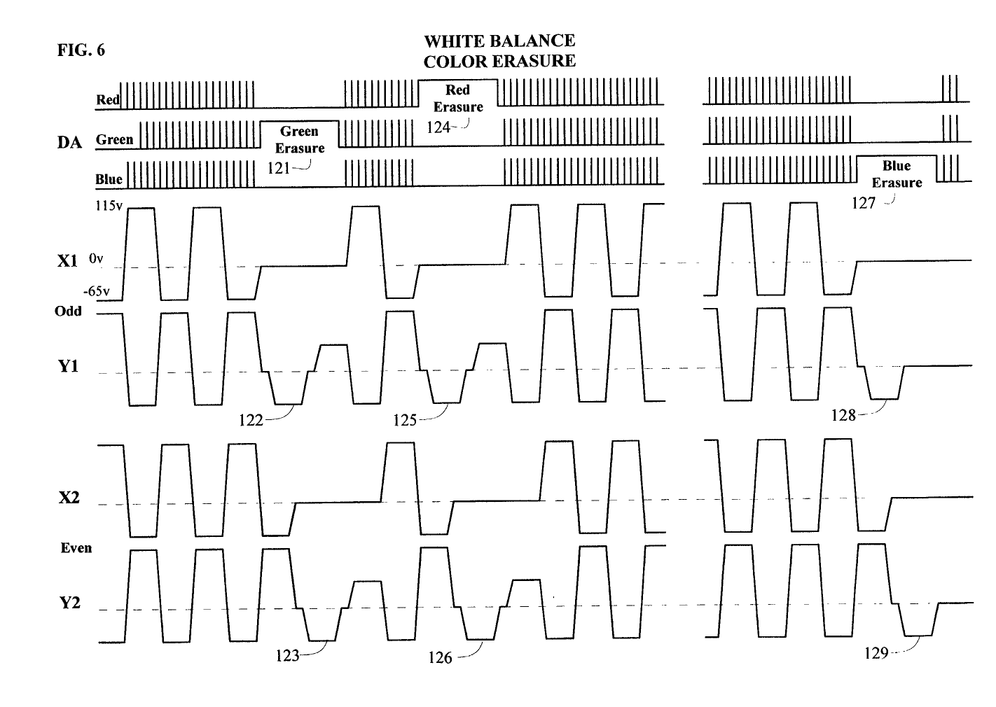

The method starts with Step One “111”, of displaying one sub-field of picture using the ADT method which divides the display into segments which are driven independently by individually controlled drive blocks “93˜95”. That is, during the sustain period of each drive block “93˜95” a plurality of sustain pulses, whose number is based upon the gray-scale weight of this subfield plus the brightness level, provide light output on the screen. Step Two “112” adjusts the number of sustain pulses of Step One so that the independently driven blocks of the display screen will maintain a luminous uniformity. If for example there is a large difference in the number of cells on in different segments of the display, then sustain pulses are subtracted or added to the sub-field in each drive block “93˜95” in order to obtain uniform luminous from all cells of the display screen. Step Three “113” is an erasure of green color cells only in a drive block of the display screen. This is timed nearer to the end of the sustain pulses for a sub-field. Illustrated in FIG. 6, are waveforms showing the method of erasure for all the green color cells in a drive block “93˜95”. For example a 1080 row display that is divided into five drive blocks will only have 108 odd electrodes and 108 even electrodes per block, therefore the erase pulse of the column data driver IC has a maximum load of 108 rows. The erasure of the green color is accomplished by taking only the green data electrodes high “121”, while keeping the red and blue data electrodes low. First the Odd Y electrode is pulsed negative “122” which causes an erasure of all Odd green cells, Then the Even Y electrode is pulsed negative “123” causing the erasure of Even green cells. Remember only the green color cells have been erased, on red and blue color cells still have wall charge. Step Four “114” is a continuation of the sustain pulses which enables the on red and blue color cells to continue with their light emissions. Step Five “115” is the erasure of the on red color cells of a drive block “93˜95”. The method is the same as in Step Three “113” except the red column data “124” is now selected plus Odd Y electrode pulse “125” and Even Y electrode pulse “126”. Step Six “116” is again a continuation of the sustain pulses, except now only the on blue color cells emit light. Step Seven “117” is at the end of sustain pulses and is an erasure of on blue color cells “127˜128” in preparation for the next subfield.

The method of the above erasure is as follows. A data pulse applied to only one color is selected (positive in this example). At the same time, a select pulse is applied to all Y odd electrodes of one block (negative in this case). A cell in which light-emission discharges have been sustained in the present sub-field retains the wall charge formed in the last surface discharge. For this reason, the application of the selected data and row pulses causes an opposition discharge, which has a priming effect of inducing a surface discharge, in the preceding selected cell. If the crest values of the select pulses are properly selected, the surface discharge finishes when the remaining wall charge is neutralized to disappear, and new wall charge is not formed or, if formed, is extremely insignificant. In this case, since the opposition discharge is generated as a trigger for the surface discharge, residual charge around the address electrode also disappears. Therefore, the proceeding selected cells falls in a substantially non-charged state. The above process is repeated for the Y even electrodes of the selected drive block. Since cells, which have not, emitted light in the sub-field is in the non-charged state; all the cells of the entire color of the screen become non-charged state by the erasure.

The erasure could also be between the X electrode and data electrode which means the resolution for white balance is to one sustain discharge. Adjusting the number of sustain pulses of each color during every subfield results in a perfect white balance and is a much simpler way to perform white balance than prior methods are.

While the invention has been described as having specific embodiments, it will be understood that it is capable of further modification. This application is, therefore, intended to cover any variations, uses or adaptations of the invention following the general principles thereof and including such departures from the present disclosure as come within known or customary practice in the art to which this invention pertains and fall within the limits of the appended claims.

What is claimed is:

1. A method of driving a plasma display panel having a plurality of independently driven display drive blocks of green, red and blue cells, wherein each image is displayed on the panel by addressing on desired green, red and blue cells in each drive block and sustaining the on cells with a desired number of sustain pulses, said method comprising the step of:
adjusting the number of sustain pulses of one of said green, red or blue cells of each drive block, whereby a white balance is obtained on the display panel.

2. The method of driving a plasma display panel of claim 1 wherein, during said step of adjusting, the number of sustain pulses of the green cells is decreased.

3. The method of driving a plasma display panel of claim 2 further wherein the number of sustain pulses of the red cells is decreased.

4. The method of driving a plasma display panel of claim 1 wherein, prior to the step of adjusting, the number of on green, red and blue cells of each display drive block is determined.

5. The method of driving a plasma display panel of claim 4 wherein, during said step of adjusting, the number of sustain pulses of the green cells is decreased.

6. The method of driving a plasma display panel of claim 5 further wherein the number of sustain pulses of the red cells is decreased.

7. The method of driving a plasma display panel of claim 3 wherein said adjustment for each drive block is determined by the number of on green, red and blue cells in the drive block.

8. The method of driving a plasma display panel of claim 1 wherein said adjustment for each drive block is determined by the number of on green, red and blue cells in the drive block.
